(19) United States
(12) Patent Application Publication
(10) Pub. No.: US 2007/0280577 A1
(43) Pub. Date: Dec. 6, 2007

(54) Optical multi-wavelength modulator

(75) Inventor: Hung-Chih Lu, Guanyin Township (TW)

Correspondence Address: TROXELL LAW OFFICE PLLC, SUITE 1404, 5205 LEESBURG PIKE, FALLS CHURCH, VA, 22041, US

(73) Assignee: Way-Seen Wang

(21) Appl. No.: 11/440,443

(22) Filed: May 25, 2006

(51) Int. Cl. G02F 1/01

(52) U.S. Cl. 385/1

(57) ABSTRACT

The present invention is an optical modulator. It is fit for various wavelengths. The present invention has a logic signal of ‘0’ with a high signal level. The present invention has a high resist to noise. The present invention has advantages of a short length and a thin width to be applied to any optoelectronic related device or system.

### FIELD OF THE INVENTION

The present invention relates to an optical modulator; more particularly, relates to integrating an optical multi-wavelength modulator into a single chip.

### DESCRIPTION OF THE RELATED ART

Traditional data transmission, no matter it is between servers, computers, plastic circuit boards (PC B), integrated circuits (IC) or chips, is done along electric wires. Since central processing unit (CPU) is getting faster and faster, a physical limitation of an electric wire appears. Therefore, an optical connection to transfer data through fiber and optical device has become the most effective and workable solution.

At the present time, an optical connection between a server and a client computer has been realized, while the optoelectronic device used is still an independent device. That is to say, in the future, the optical connection between the PCBs, the ICs, the chips or sub-systems in a chip has to use optical devices integrated in a single chip to reduce the size and to lower the cost.

A general optical device is used in an optical communication, which is an independent item of a large size; and the substrate and the material used in the active and the passive devices are different. In order to integrate various optical devices into a single silicon chip, the optical route, the refinement of the optical device and the integration of the optical devices are the most essential.

A general optical integrated multi-wavelength transmitting/receiving system is one of the core system. And the optical multi-wavelength modulator is the key component. Yet, the optical device still meets its size limitation owing to its independence, lack of integration. Hence, the prior art does not fulfill users' requests on actual

### SUMMARY OF THE INVENTION

The main purpose of the present invention is to provide an optical multi-wavelength modulator integrated into a single chip.

To achieve the above purpose, the present invention is an optical multi-wavelength modulator, comprising a 2×2 N paired wavelength division multiplexer and an optical modulator.

The paired wavelength division multiplexer is an arrayed waveguide grating unit with reflective star coupler or a reflective grating unit, where the arrayed waveguide grating unit with reflective star coupler comprises an input terminal, an output terminal, a first reflective star coupler, an arrayed waveguide and a second reflective star coupler; the reflective star coupler is a refined general star coupler; and the length of the coupler is greatly reduced to shrink the size of the arrayed waveguide grating unit.

The reflective grating unit comprises an input terminal, an output terminal, two mirror gratings and a concave mirror, where, through times of reflections by the mirror gratings, light of various wavelength is divided to be focused to various output waveguides by the concave mirror.

The optical modulator has at least one optical modulation unit and the optical modulation unit is an optical grating modulation unit or an optical modulation unit having an annular resonator, where the optical grating modulation unit comprises a grating structure and a light-coupling structure; the grating structure reflects a certain light of wavelength through a periodical change in a waveguide structure or in a refractive index of a waveguide; the light-coupling structure is a directional coupler structure, a multi mode interference structure, a Mach -Zehnder interferometer structure or a directional coupler structure assisted with a multi mode interference.

The optical grating modulation unit using a directional coupler structure couples a light by an input waveguide into two parallel waveguides to be outputted to the output waveguide. The optical grating modulation unit using a multimode interference structure couples the light by an input waveguide into an output waveguide through a mode interference after the light is transmitted to a multimode interference area. The optical grating modulation unit using a Mach-Zehnder interferometer structure couples the light by an input waveguide into two waveguides in an operational area through a first 3-decibel (dB) directional coupler structure; and, after a phase control, the light is coupled into a specific output waveguide through a second 3 dB directional coupler structure. The optical grating modulation unit using a directional coupler structure assisted with a multimode interference couples the light by an input waveguide into two parallel waveguides; and at least one multi mode interference structure is added between two parallel waveguides so that a light coupling efficiency is improved and the light is coup led to a specific output waveguide.

By combining the grating structure and the light-coupling structure, a light of a specific wavelength is reflected, where the light is not reflected after the phase changes; a second output waveguides has a logic signal of ‘0’; and a waveguide outputting reflective modulated signal has a logic signal of ‘1’. In the other hand, after another phase change, the band of the reflected light is shifted so that the original light of wavelength is not reflected, but is totally transmitted with a logic signal of ‘1’ to the second output waveguide outputting transmitted modulated signals while the waveguide outputting reflective modulated signal has a logic signal of ‘0’.

The optical modulator of bidirectional bi-annular resonator comprises a straight waveguide and an annular coupling structure, where light is coupled by an input waveguide into two resonance cavities of an annular coupling structures the output waveguide with a logic signal of ‘0’ after a phase change, the resonance frequency is shifted and the original light of wavelength is no more coupled to the resonance cavities but is totally coupled to the output waveguide with a logic signal of ‘1’. Thus, through a coupling structure between two resonance cavities of two annular resonators, an operational band and wavelength are increased. Accordingly, a novel optical multi-wavelength modulator is obtained.

### BRIEF DESCRIPTION OF THE DRAWINGS

The present invention will be better understood from the following detailed descriptions of the preferred embodiments according to the present invention, taken in conjunction with the accompanying drawings, in which

FIG. 1 is a structural view according to the present invention ;

FIG.2A is a structural view showing the arrayed waveguide grating unit with reflective star coupler;

FIG. 2B is a structural view showing the reflective grating unit;

FIG. 3A is a structural view showing the optical grating modulation unit using a directional coupler structure;

FIG.3B is a structural view showing the optical grating modulation unit using a multi mode interference structure; FIG. 3C is a structural view showing the optical grating modulation unit using a Mach-Zehnder interferometer structure;

FIG. 3D is a structural view showing the optical grating modulation unit using a directional coupler structure assisted with a multimode interference;

FIG.3E is a structural view showing the optical modulation unit using a bidirectional bi-annular resonance structure; and

FIG.4 is a simulation view showing the spectrum and the characteristic.

### DESCRIPTION OF THE PREFERRED EMBODIMENTS

The following descriptions of the preferred embodiments are provided to understand the features and the structures of the present invention.

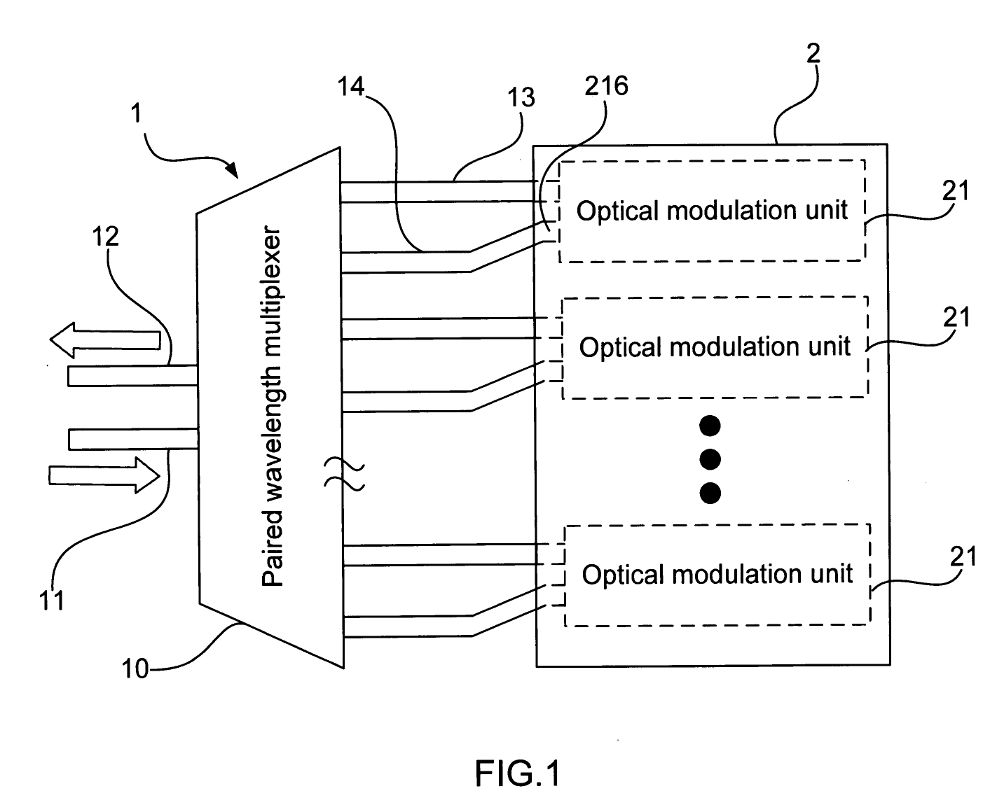

Please refer to FIG. 1, which is a structural view according to the present invention. As shown in the figure, the present invention is an optical multi-wavelength modulator, comprising a 2×2N paired wavelength division multiplexer 1 and an optical modulator 2.

The paired wavelength division multiplexer 1 comprises a wavelength division multiplexer unit 10, an input terminal 11, an output terminal 12, a first output waveguide 13 and a first input waveguide 14, where the wavelength division multiplexer unit 10 is a refined arrayed waveguide grating unit with reflective star coupler; a reflective grating unit; or a general arrayed waveguide grating unit. The paired wavelength division multiplexer 1 has a pair of inputs and a pair of outputs from a pair of 1×N wavelength division multiplexers (like arrayed waveguide grating) without changing the main structure of the wavelength division multiplexers.

The optical modulator 2 comprises at least one optical modulation unit 21, where the optical modulation unit 21 is an optical grating modulation unit or an optical modulation unit having an annular resonator; and the optical grating modulation unit is an optical grating modulation unit using a directional coupler structure, an optical grating modulation unit using a multimode interference structure, an optical grating modulation unit using a Mach-Zehnder interferometer structure, or an optical grating modulation unit using a directional coupler structure assisted with a multi mode interference.

The paired wavelength division multiplexer 1 uses the input terminal 11 to receive a light source. The light source is divided into N parts of bandwidth by the paired wavelength division multiplexer 1. Each bandwidth is transferred by the output waveguide 13 to the optical modulation unit 21 of the optical modulator 2. The bandwidth is modulated by the optical modulation unit 21. A modulated signal after reflection is obtained. By connecting an waveguide outputting reflective modulated signal 216 with the first input waveguide 14 of the paired wavelength division multiplexer 1, light fields of various wavelengths are modulated into light signals to be reversely transferred back to the paired wavelength division multiplexer 17 to be outputted by the output terminal 12. Thus, by using a paired wavelength division multiplexer 1 and an optical modulator 2 according to the present invention, optical signals of various wavelengths are obtained; and a whole size of the present invention is further shortened and desized to be integrated into a single chip.

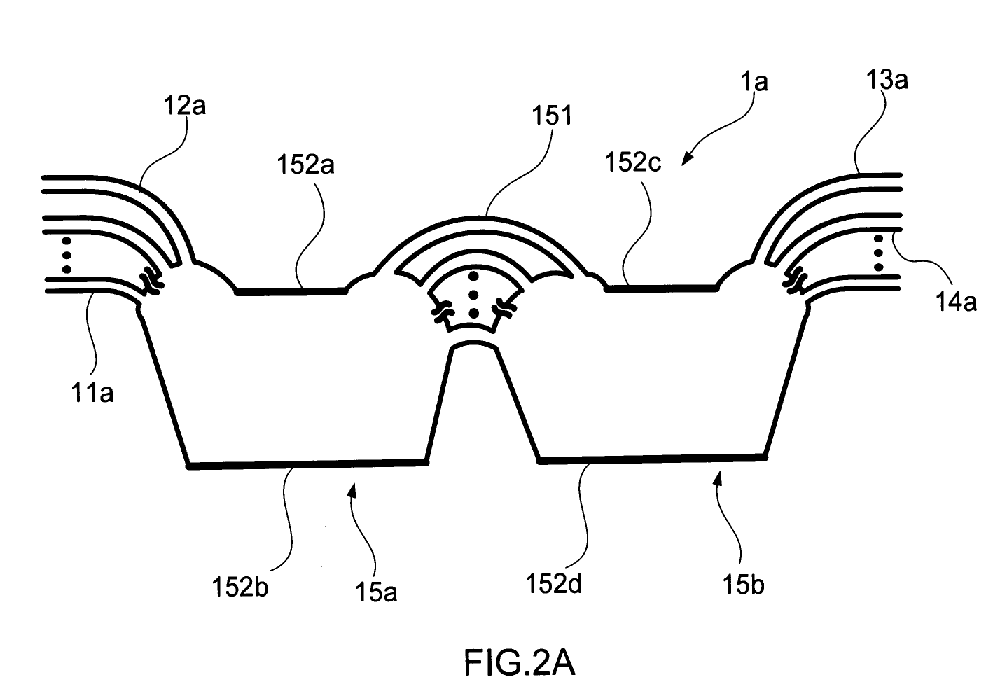

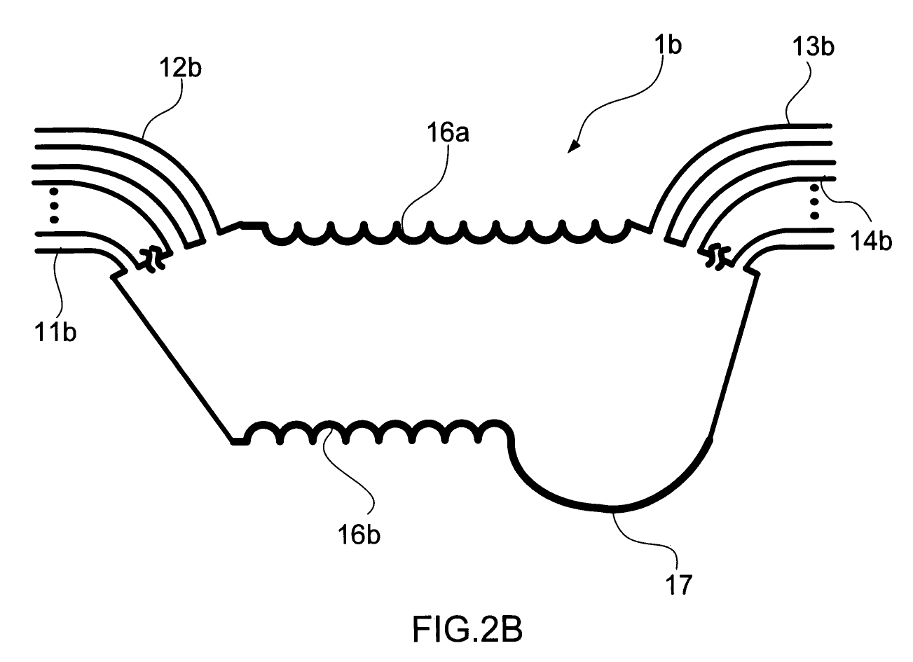

Please refer to FIG. 2A, which is a structural view showing the arrayed waveguide grating unit with reflective star coupler. As shown in the figures, the paired wavelength division multiplexer of the present invention is an arrayed waveguide grating unit with reflective star coupler 1a, comprising an input terminal 11a, an output terminal 12a, a first reflective star coupler 15a, at least one arrayed waveguide 151, a second reflective star coupler 15b, at least one first output waveguide 13a and at least one first input waveguide 14a, where the first and the second reflective star couplers 15a, 15b are two refined general star couplers connected through an arrayed waveguide and have two mirrors 152a, 152b, 152c, 152d separately; another end of the first reflective star coupler 15a to the arrayed waveguide is connected to the input terminal 11a and the output terminal 12a; another end of the second reflective star coupler 15b to the arrayed waveguide is connected to the first output waveguide 13a and the first in put waveguide 14a the in put terminal 11a comprises at least one input waveguide; and the output terminal 12a comprises at least one output waveguide.

When light source enters from the input terminal 11a, a light field is propagated in the first reflective star coupler 15a. When the light field arrives at the two mirrors 152a, 152b of the first reflective star coupler 15a, the light field reflects and a fild size obtained is increased constantly to be coupled to the arrayed wave guide 151 in the end. After the light field passes through the arrayed waveguide 151 to obtain a phase difference, light field is focused again at the second reflective star coupler 15b and is reflected to the first output waveguide 13a through the mirrors 152c, 152 d for dividing light having various wavelength. Therein, the mirrors 152a, 152b, 152c, 152d of the first and the second reflective star couplers 15a, 15b have an etched surface, an etched surface with a high-reflection coating, an etched surface with a metal coating, a photon crystal, or a grating. The reflective star coupler structure made of the above first and second reflective star couplers 15a, 15b is greatly decreased in length and so the size of the arrayed waveguide grating unit is shortened.

Please refer to FIG. 2B, which is a structural view showing the reflective grating unit. As shown in the figure, the paired wavelength division multiplexer of the present invention is a reflective grating unit 1b, comprising an input terminal 11b, an output terminal 12b, two mirror grating 16a, 16b, a concave mirror 17, at least one first output waveguide 13b, and at least one first input waveguide, where the input terminal 11b comprises at least one input waveguide and the output terminal 12b comprises at least one output waveguide.

When a light source enters from the input terminal 11b, a light field is propagated in the reflective grating unit 1b. When the light field arrives at the two mirrors 16a, 16b, the light field is reflected for times where the light field comprises various wavelengths having various reflecting angles. After the reflections, the light field is divided into at least one light route having various wavelength. Then the light route having various wavelength is scattered by the concave mirror 17 to be focused at various first output waveguide 13b for separate various light of wavelength. Hence, the reflective grating unit 1b has an extremely small size to be integrated easily.

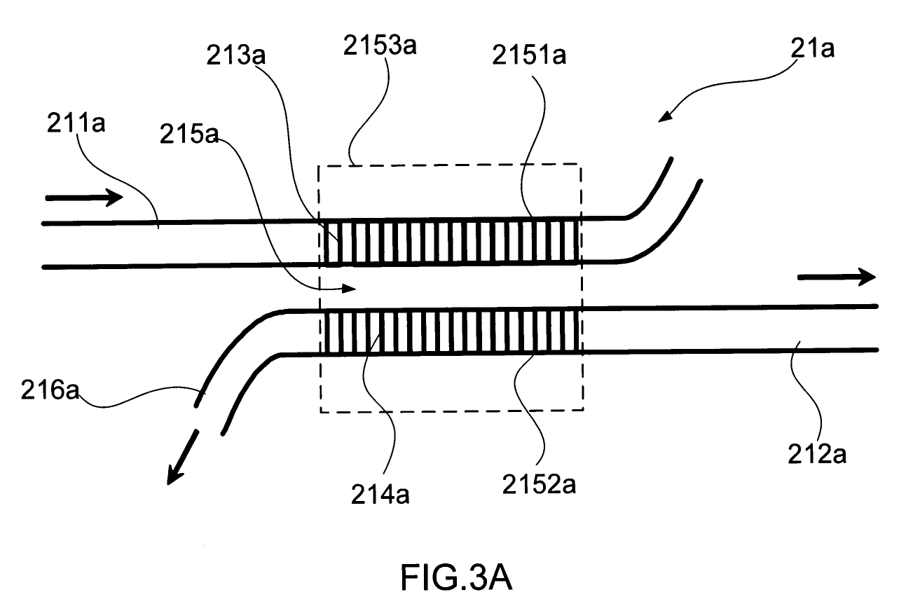

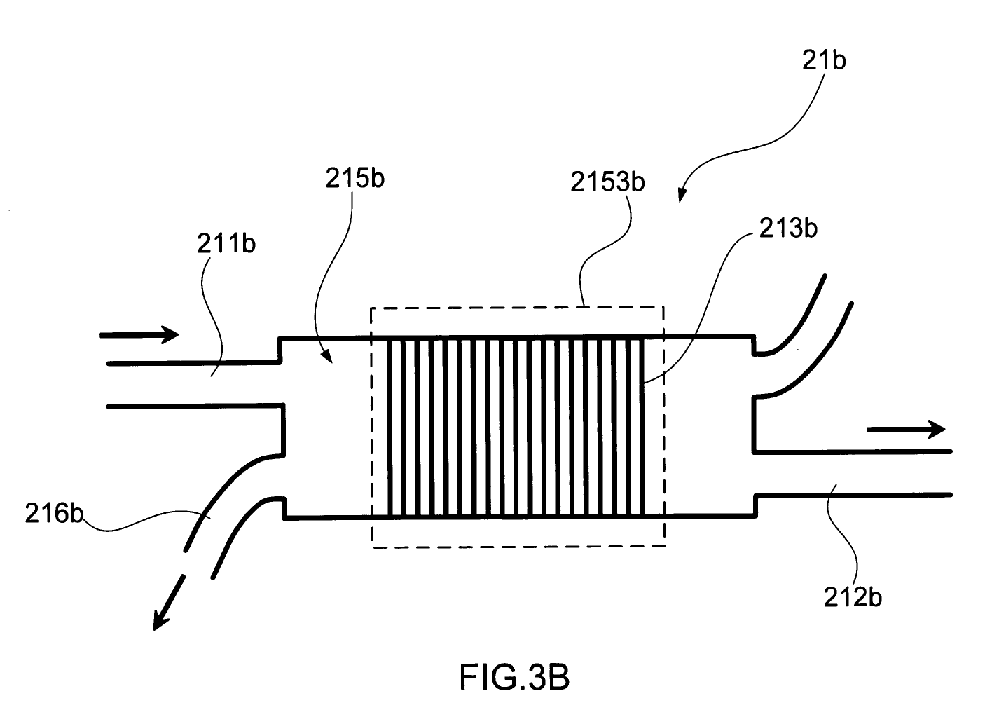

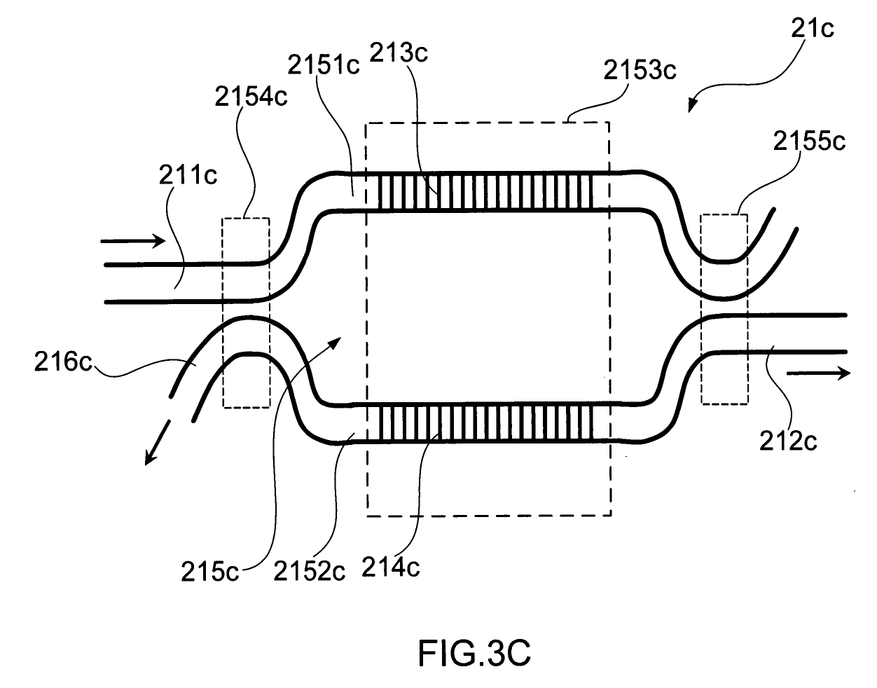

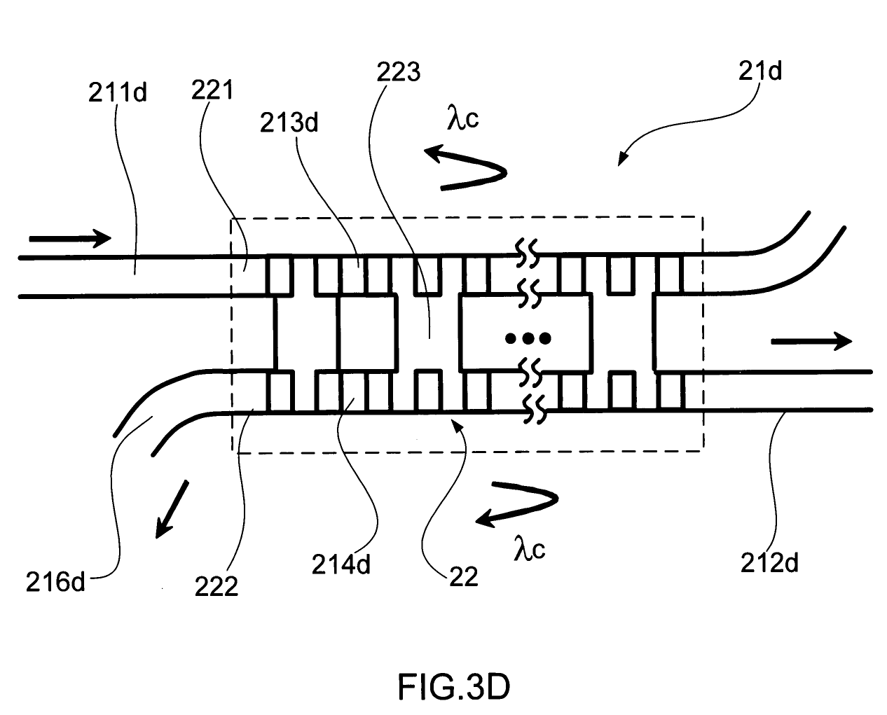

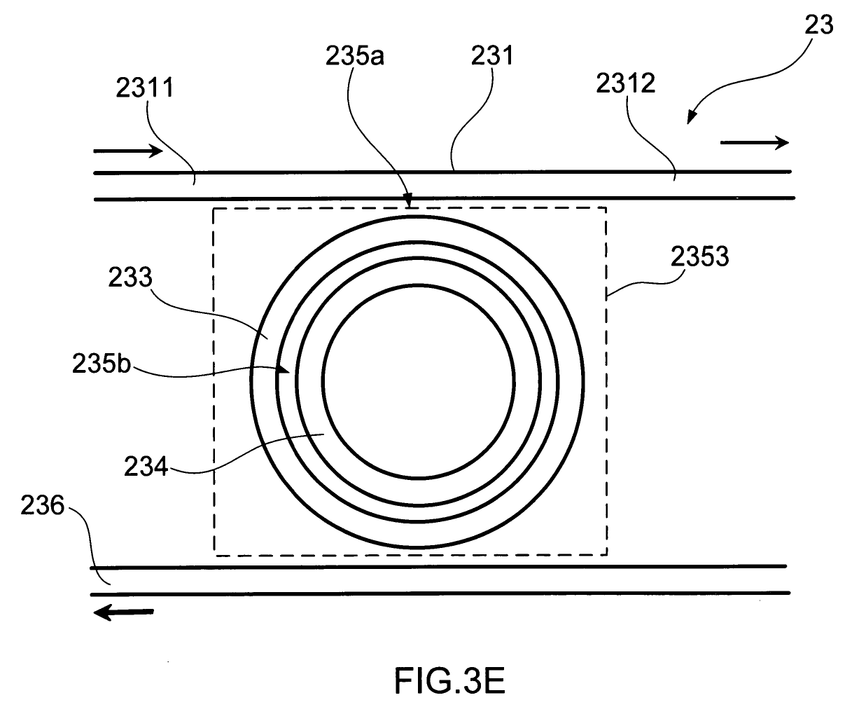

Please refer to FIG.3A, which is a structural view showing the optical grating modulation unit using a directional coupler structure. The optical modulation unit according to the present invention reflects a certain light of wavelength through a periodical change in a wavelength structure or in a refractive index of a waveguide. As shown in the figure, the optical modulation unit according to the present invention is an optical grating modulation unit using a directional coupler structure 21a, which comprises a second input waveguide 211a, a second output waveguide 212a, at least one grating structure 213a,214a, a light-coupling structure using a directional coupler structure 215a, and an waveguide outputting reflective modulated signal 216a. When using the optical grating modulation unit using a directional coupler structure 21a, the second input waveguide 211a receives a non-modulated continuous wave light source outputted from a paired wavelength division multiplexer. After the light source enters into the directional coupler structure 215a, a light is gradually coupled from a first parallel waveguide 2151a of the directional coupler structure 215a into a second parallel waveguide 2152a of the directional coupler structure 215a to be outputted from the second output waveguide 212a. Two of the grating structures 213a,214a are separately set in the first parallel waveguide 2151a and the second parallel waveguide 2152a and thus the light field is changed when being coupled in the directional coupler structure 215a. That is, when the wavelength of the light field does not lie within the reflective wavelength band of the grating structures 213a,214a, the grating structures 213a,214a do not function; and so the light field is outputted from the second output waveguide 212a, where the outputted energy of the light field is 100% as a logic signal of ‘1’.

On the contrary, when the wavelength of the light field lies within the reflective wavelength band of the grating structures 213a,214a, the grating structures 213a,214a is functioned to reflect the light field to be coupled to the waveguide outputting reflective modulated signal 216a, whose logic signal is ‘1’. Therein, the light energy of the light field outputted from the second output waveguide 212a is 0% as a logic signal of ‘0’. At this moment, if a light field is required to be outputted from the second output waveguide 212a, a wavelength of the light field is fixed and a reflective wavelength band of the grating structures 213a,214a is changed through the modulation area 2153a of the optical modulation unit 21a to pass and output the light field from the second output waveguide 212a, whose logic signal is ‘1’. Therein, the logic signal of the waveguide outputting reflective modulated signal 216a is ‘0’. Yet the light field is still possible to be reflected by the grating structures again to be outputted by the waveguide outputting reflective modulated signal 216a so that the logic signal of the second output waveguide 212a is ‘0’ and the logic signal of the waveguide outputting reflective modulated signal 216 a is Please refer to FIG. 3B, which is a structural view showing the optical grating modulation unit using a multimode interference structure. As shown in the figure, the optical modulation unit according to the present invention is an optical grating modulation unit using a multimode interference structure 21b, which comprises a second input waveguide 21b, a second output waveguide 212b, at least one grating structure 213b, a light-coupling structure using a multi mode interference structure 215b, and an waveguide outputting reflective modulated signal 216b. When using the optical grating modulation unit using a multimode interference structure 21b, the second input waveguide 211b receives a non-modulated continuous wave light source outputted from a paired wavelength division multiplexer. After the light source enters into the multimode interference structure 215b, the light field changed from a single mode to a multimode and the modes are constructive interfered. Finally, a self-imaging is obtained to be outputted from the second output waveguide 212b. The grating structure 213b is set in a multimode interference area of the multimode interference structure 215b and thus the light field is changed when being coupled in the multimode interference structure 215b. That is, when the wavelength of the light field does not lie within the reflective wavelength band of the grating structures 213b, the grating structures 213b do not function; and so the light field is outputted from the second output waveguide 212b, where the outputted energy of the light field is 100% as a logic signal of ‘1’.

On the contrary, when the wavelength of the light field lies with in the reflective wavelength band of the grating structures 213b, the grating structures 213b is functioned to reflect the light field to be coupled to the waveguide outputting reflective modulated signal 216b, whose logic signal is ‘1’. There in, the light energy of the light field outputted from the second output waveguide 212b is 0% as a logic signal of ‘0’. At this moment, if a light field is required to be outputted from the second output waveguide 212b, a wavelength of the light field is fixed and a reflective wavelength band of the grating structures 213b is changed through the modulation area 2153b of the optical modulation unit 21b to pass and output the light field from the second output waveguide 212b, whose logic signal is ‘1’. The rein, the logic signal of the waveguide outputting reflective modulated signal 216b is ‘0’. Yet the light field is still possible to be reflected by the grating structures again to be outputted by the waveguide outputting reflective modulated signal 216b so that the logic signal of the second output waveguide is ‘0’ and the logic signal of the waveguide outputting reflective modulated signal is ‘1’.

Please refer to FIG. 3C, which is a structural view showing the optical grating modulation unit using a Mach-Zehnder interferometer structure. As shown in the figure, the optical modulation unit according to the present invention is an optical grating modulation unit using a Mach-Zehnder interferometer structure 21c, which comprises a second input waveguide 211c, a second output waveguide 212c, at least one grating structure 213c,214c, a light-coupling structure of Mach-Zehnder interferometer structure 215c, and an waveguide outputting reflective modulated signal 216c. When using the optical grating modulation unit using a Mach-Zehnder interferometer structure 21c, the second input waveguide 211c receives a non-modulated continuous wave light source outputted from a paired wavelength division multiplexer. After the light source enters into the Mach-Zehnder interferometer structure 215c, a light field outputted from a first 3 dB directional coupler structure 2154c is evenly spread to a first parallel waveguide 2151c of the Mach-Zehnder interferometer structure 215c and a second parallel waveguide 2152c of the Mach-Zehnder interferometer structure 215c. By a phase controlling, the light field is finally coupled and outputted to the second output waveguide 212c through a second 3 dB directional coupler structure 2155c. Two of the grating structures 213c,214c are separately set in the first parallel waveguide 2151c and the second parallel waveguide 2152c and thus the light field is changed when being coupled in the Mach-Zehnder interferometer structure 215c. That is, when the wavelength of the light field does not lie with in the reflective wavelength band of the grating structure s 213c,214c, the grating structures 213c,214c do not function; and so the light field is outputted from the second output waveguide 212c, where the outputted energy of the light field is 100% as a logic signal of On the contrary, when the wavelength of the light field lies within the reflective wavelength band of the grating structures 213c,214c, the grating structures 213c,214c is functioned to reflect the light field to be coupled to the waveguide outputting reflective modulated signal 216c, whose logic signal is ‘1’. The rein, the light energy of the light field outputted from the second output waveguide 212c is 0% as a logic signal of ‘0’. At this moment, if a light field is required to be outputted from the second output waveguide 212c, a wavelength of the light field is fixed and a reflective wavelength band of the grating structures 213c,214c is changed through the modulation area 2153c of the optical modulation unit 21c to pass and output the light field from the second output waveguide 212c, whose logic signal is ‘1’. Therein, the logic signal of the waveguide outputting reflective modulated signal 216c is ‘0’. Yet the light field is still possible to be reflected by the grating structures again to be outputted by the waveguide outputting reflective modulated signal 216c so that the logic signal of the second output waveguide 212c is ‘0’ and the logic signal of the waveguide outputting reflective modulated signal is ‘1’.

Please refer to FIG. 3D, which is a structural view showing the optical grating modulation unit using a directional coupler structure assisted with a multimode interference. As shown in the figure, the optical modulation unit according to the present invention is an optical grating modulation unit using a directional coupler structure assisted with a multimode interference 21d, constructed with an optical grating modulation unit using a directional coupler structure 21a (as shown in FIG.3A) and a directional coupler structure assisted with a multimode interference 22, where the directional coupler structure 215a (as shown in FIG. 3A) as a part of the optical grating modulation unit using a directional coupler structure 21a is replaced with the directional coupler structure assisted with a multimode interference 22 to further shorten the length.

The optical grating modulation unit using a directional coupler structure assisted with a multimode interference 21d comprises a second input waveguide 211d, a second output waveguide 212d, two grating structures 213d,214d, an waveguide outputting reflective modulated signal 216d, and a directional coupler structure assisted with a multimode interference 22, where the directional coupler structure assisted with a multimode interference 22 comprises a first parallel waveguide 221, a second parallel waveguide 222, and at least one multi mode interference are a 223; the multimode interference area 223 is located between the first parallel waveguide 221 and the second parallel waveguide 222; and every multimode interference area 223 has a various length.

Through the second input waveguide 211d, the optical grating modulation unit using a directional coupler structure assisted with a multi mode interference 21d receives a non-modulated continuous wave light source outputted from a paired wavelength division multiplexer. After the light source enters into the directional coupler structure assisted with a multimode interference 22, a light is gradually coupled from a first parallel waveguide 221 of the directional coupler structure assisted with a multi mode interference 22 into a second parallel waveguide 222 of the directional coupler structure assisted with a multi mode interference 22 to be outputted from the second output waveguide 212d. Two of the grating structures 213d,214d are separately set in the first parallel waveguide 221 and the second parallel waveguide 222 and thus the light field is changed when being coupled in the directional coupler with a multimode interference structure 22.

Please refer to FIG. 3E, which is a structural view showing the optical modulation unit using a bidirectional bi-annular resonance structure. As shown in the figure, the optical modulation unit using a bidirectional bi-annular resonance structure according to the present invention comprises a straight waveguide 231, a first annular waveguide 233, a second annular waveguide 234 and an waveguide outputting reflective modulated signal 236, where the straight waveguide 231 has a third input waveguide 2311 and a third output waveguide 2312; and the first annular waveguide 233 is made by circling a single-mode waveguide. A coupling is happened between the first annular waveguide 233 and the straight waveguide 231 so that a first annular resonance coupling structure 235a is obtained. In the other hand, a second annular waveguide 232 is further set in the first annular waveguide 231; and a second annular coupling structure 235b is obtained with the first annular waveguide 233 and the second annular waveguide When using the optical modulation unit using a bi-annular resonator 23, the third input waveguide 2311 receives a non-modulated continuous wave light source outputted from a paired wavelength division multiplexer. After the light source enters into the directional coupler structure 235a when the wavelength of the light field lies with in an bi-annular resonance band, the light field is coupled into a resonance cavity. At this moment, no light field is outputted from the third output waveguide 2312, whose logic signal is ‘0’. Light field in the bi-annular resonator is formed to obtain a reflective modulated signal by a coupling in the waveguide outputting reflective modulated signal 236 through a bi-directional transmission. Thus, a modulated signal and a reflective modulated signal are provided at the same time.

In addition, for obtaining a light field from the third output waveguide, a voltage or a current is further added to a modulation area to change the effective refractive index of the waveguide so that the resonance band is shifted and the light field is not coupled to the resonance cavity. Consequently, the light field is transmitted to the third output waveguide 2312 as a logic signal of ‘1’; and, in this way, an electrical signal can be transformed to an optical signal. It is clear that the optical modulation unit using a bidirectional bi-annular resonance structure 23 has a wide operational band for a multi-wavelength operation.

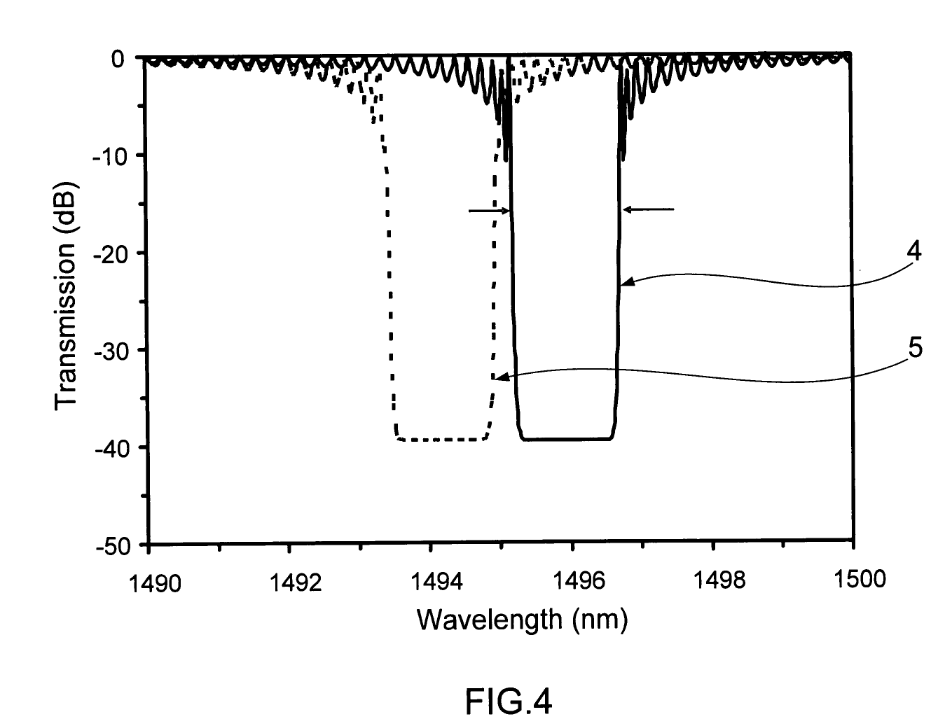

Please refer to FIG. 4, which is a simulation view showing the spectrum and the characteristic. The present invention is an optical multi-wavelength modulator, comprising a paired wavelength division multiplexer and an optical modulator, where the paired wavelength division multiplexer is an arrayed waveguide grating unit with reflective star coupler or a reflective grating unit; the optical modulator has at least one optical modulation unit; the optical modulation unit is an optical grating modulation unit using a directional coupler structure, an optical grating modulation unit using a multimode interference structure, an optical grating modulation unit using a Mach-Zehnder interferometer structure, an optical grating modulation unit using a directional coupler structure assisted with a multi mode interference, or an optical modulation unit using a bidirectional bi-annular resonance structure. By changing a refractive index of the grating structure in a coupling area through a voltage or a current, a reflective band of the grating is shifted to decide whether passing a light field or not so that an optical logic signal of ‘1’ or ‘0’ is obtained at an output waveguide of every optical modulation unit.

As shown in the figure, the simulation curve 4 shows the transmission wavelength band of the optical multi-wavelength modulator when reflective wavelength band of grating is unchanged; and the simulation curve 5 shows the shifted transmission wavelength band when reflective wavelength band of grating is changed by modulating. When operation wavelength is fixed, the logical signals can be modulated by changing the reflective wavelength band of grating. Hence, the optical multi-wavelength modulator according to the present invention is operated under a transmission energy of 12 decibel with a band wider than 1.5 nanometer (nm), where the present invention is fit for multi-wavelength; the logic signal of ‘0’ has a high isolation level; and the present invention has a high resist to noise with advantages of a device length shorter than 2 mm and a width thinner than 4 micron.

To sum up, the present invention is an optical multi-wavelength modulator, where the present invention is fit for mu It i-wavelength operation with a high resist to noise, a high level ratio between logic signal ‘1’ and ‘0’, and advantages of a device length of the optical grating modulation unit shorter than 2 mm and a width of the optical grating modulation unit thinner than 4 micron.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

1. An optical multi-wavelength modulator, comprising a paired wavelength division multiplexer, said paired wavelength division multiplexer comprising a wavelength division multiplexer unit, an input terminal, an output terminal, at least one first output waveguide and at least one first input waveguide; and
an optical modulator, said optical modulator comprising at least one optical modulation unit, wherein said multiplexer and said optional modulator are configured to be located on a single chip.

2. The optical multi-wavelength modulator according to claim 1,
wherein said wavelength division multiplexer unit is selected from a group consisting of an arrayed waveguide grating unit with reflective star coupler, and a reflective grating unit.

3. The optical multi-wavelength modulator according to claim 2,
wherein said arrayed waveguide grating unit with reflective star coupler comprises a first reflective star coupler, a second reflective star coupler and at least one arrayed waveguide.

4. The optical multi-wavelength modulator according to claim 3,
wherein each of said first reflective star coupler has two mirrors; and
wherein said second reflective star coupler has two mirrors.

5. The optical multi-wavelength modulator according to claim 4,
wherein said mirror has a surface selected from a group consisting of an etched surface, an etched surface having a high-reflection coating, an etched surface having a metal coating, a photon crystal, and a grating.

6. The optical multi-wavelength modulator according to claim 2,
wherein said reflective grating unit has two mirror gratings and a concave mirror.
wherein said mirror grating and concave mirror have a surface selected from a group consisting of an etched surface, an etched surface having a high-reflection coating, an etched surface having a metal coating, a photon crystal, and a grating.

7. The optical multi-wavelength modulator according to claim 1,
wherein said paired wavelength division multiplexer is a arrayed waveguide grating unit.

8. The optical multi-wavelength modulator according to claim 1,
wherein said optical modulation unit uses a structure selected from a group consisting of an optical grating modulation unit structure and an optical modulation unit having an annular concentric ring resonator structure.

9. The optical multi-wavelength modulator according to claim 8,
wherein said optical grating modulation unit structure comprises a grating structure, a light-coupling structure, a second input waveguide, a second output waveguide, and an waveguide outputting reflective modulated signal.

10. The optical multi-wavelength modulator according to claim 9,
wherein said light-coupling structure is selected from a directional coupler structure, a multimode interference structure, a Mach-Zehnder interferometer structure, and a directional coupler structure assisted with a multimode interference.

11. The optical multi-wavelength modulator according to claim 10,
wherein said directional coupler structure further comprises a first parallel waveguide and a second parallel waveguide.

12. The optical multi-wavelength modulator according to claim 10,

12. The optical multi-wavelength modulator according to claim 10,
wherein said Mach-Zehnder interferometer structure further comprises a first parallel waveguide, a second parallel waveguide, a first 3-decibel (dB) directional coupler structure, and a second 3 dB directional coupler structure.

13. The optical multi-wavelength modulator according to claim 10,
wherein said directional coupler structure assisted with a multimode interference comprises a directional coupler structure and at least one multimode interference structure; and
wherein said multimode interference structure is deposed between a first waveguide and a second waveguide of an operational area of said directional coupler structure assisted with a multimode interference.

14. The optical multi-wavelength modulator according to claim 8,
wherein said optical modulation unit having an annular resonator structure comprises a straight waveguide, an waveguide outputting reflective modulated signal, a first annular waveguide and a second annular waveguide; and
wherein said straight waveguide has a third input waveguide and a third output waveguide.

15. The optical multi-wavelength modulator according to claim 10,
wherein said multimode interference structure further comprises a second input waveguide, a second output waveguide, a multimode interference waveguide, and an waveguide outputting reflective modulated signal.
